(19) United States
(12) Patent Application Publication
(10) Pub. No.: US 2015/0178678 A1
(43) Pub. Date: Jun. 25, 2015

(54) PRODUCT DELIVERY SYSTEMS AND METHODS

(71) Applicant: Wal-Mart Stores, Inc., Bentonville, AR (US)

(72) Inventors: David Jon Carr, Mountain View, CA (US); Richard Mark Ramsden, Foster City, CA (US)

(73) Assignee: Wal-Mart Stores, Inc., Bentonville, AR (US)

(21) Appl. No.: 14/136,341

(22) Filed: Dec. 20, 2013

(51) Int. Cl. G06Q 10/08; G01G 19/00; G01F 17/00

(52) U.S. Cl. CPC G06Q 10/0838; G01F 17/00; G01G 19/002

(57) ABSTRACT

Example systems and methods for delivering products are described. In one implementation, a parcel shipped from an online merchant is received by a local merchant. A customer identity affixed to the parcel is used to identify a particular customer. Based on customer contact information, the customer is notified of receipt of the parcel by the local merchant. Upon receipt of a request to deliver the parcel from the customer, a delivery is scheduled to deliver both the parcel and a grocery order to the customer.

### TECHNICAL FIELD

The present disclosure relates to systems and methods that facilitate delivery of products to users.

### BACKGROUND

Customers who purchase products at online merchants need to select a method of delivery for the products. Typically, the products are shipped to the customer using a parcel delivery service or a mail service. Some parcel delivery services and mail services provide an estimated delivery date to inform the customer of when they can expect to receive the shipped products. However, the delivery dates are generally estimates and do not provide a specific delivery time (or delivery time window). Thus, customers are not provided with a definite date and time (or time window) for delivery of their products. Although some parcel delivery services and mail services offer “morning delivery,” they charge an increased fee for this service.

Many customers do not want packages left at their door if they are not home. For example, residents of apartments or condominiums may not want packages left at their door or at the outside door of the apartment complex. Since these customers do not have a specific delivery time for their products, they have difficulty receiving shipments of products purchased from online merchants.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIG. 1 is a block diagram depicting an environment within which an example embodiment may be implemented.

FIG. 2 is a block diagram depicting an embodiment of a delivery management system.

FIG. 3 is a flow diagram depicting an embodiment of a method for delivering a product from an online merchant to a local merchant location.

FIG. 4 is a flow diagram depicting an embodiment of a method for allowing a user to select a local merchant location for delivery of a product purchased from an online merchant.

FIG. 5 is a flow diagram depicting an embodiment of a method for determining delivery times for a product purchased from an online merchant.

FIG. 6 is a block diagram depicting an example computing device.

### DETAILED DESCRIPTION

In the following description, reference is made to the accompanying drawings that form a part thereof, and in which is shown by way of illustration specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the scope of the present disclosure. The following detailed description is, therefore, not to be taken in a limiting sense.

Reference throughout this specification to “one embodiment,” “an embodiment,” “one example,” or “an example” means that a particular feature, structure, or characteristic described in connection with the embodiment or example is included in at least one embodiment of the present disclosure. Thus, appearances of the phrases “in one embodiment,” “in an embodiment,” “one example,” or “an example” in various places throughout this specification are not necessarily all referring to the same embodiment or example. Furthermore, the particular features, structures, databases, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

Embodiments in accordance with the present disclosure may be embodied as an apparatus, method, or computer program product. Accordingly, the present disclosure may take the form of an entirely hardware-comprised embodiment, an entirely software-comprised embodiment (including firmware, resident software, micro-code, etc.), or an embodiment combining software and hardware aspects that may all generally be referred to herein as a “circuit,” “module,” or “system.” Furthermore, embodiments of the present disclosure may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages. Such code may be compiled from source code to computer-readable assembly language or machine code suitable for the device or computer on which the code will be executed.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction and then scaled accordingly. A cloud model can be composed of various characteristics (e.g., on-demand self-service, broad network access, resource pooling, rapid elasticity, and measured service), service models (e.g., Software as a Service (“SaaS”), Platform as a Service (“PaaS”), and Infrastructure as a Service (“IaaS”)), and deployment models (e.g., private cloud, community cloud, public cloud, and hybrid cloud).

The flow diagrams and block diagrams in the attached figures illustrate the architecture, functionality, and operation of possible implementations of systems, methods, and computer program products according to various embodiments of the present disclosure. In this regard, each block in the flow diagrams or block diagrams may represent a module, segment, or portion of code, which comprises one or more executable instructions for implementing the specified logical function(s). It will also be noted that each block of the block diagrams and/or flow diagrams, and combinations of blocks in the block diagrams and/or flow diagrams, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flow diagram and/or block diagram block or blocks.

The systems and methods described herein manage the delivery of products purchased from an online merchant to a local merchant location. Additionally, the described systems and methods manage scheduling of the delivery of the products from the local merchant location to a customer (also referred to herein as a “user”). In some embodiments, the products received by the local merchant are delivered to the user along with a grocery order from the local merchant. Although particular embodiments discussed herein refer to delivery of received products with a grocery order, the described systems and methods are useful in delivering received products with any type of order containing any type of item(s).

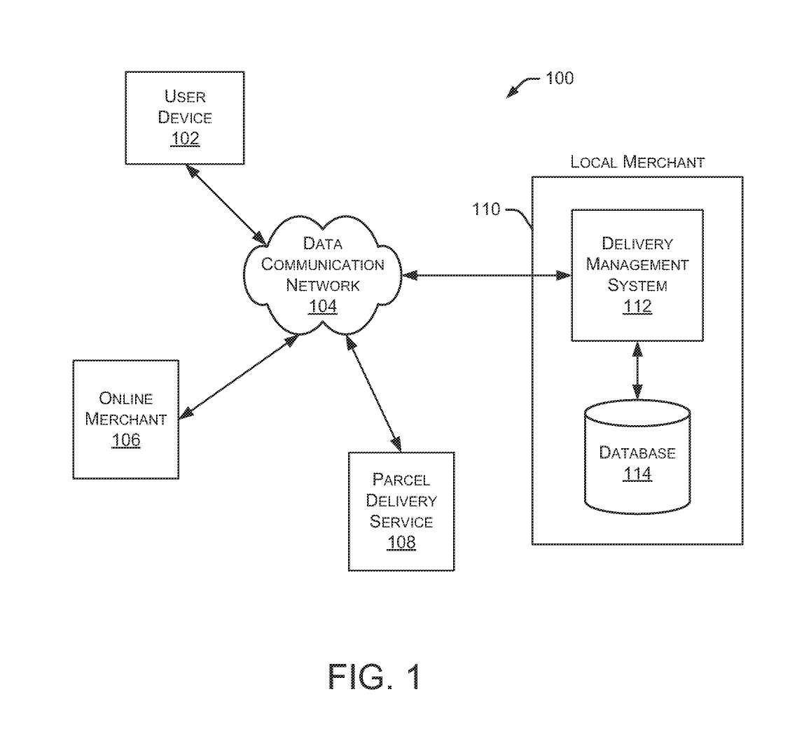

FIG. 1 is a block diagram depicting an environment 100 within which an example embodiment may be implemented. Environment 100 includes a user device 102 coupled to a data communication network 104, such as the Internet. Although one user device 102 is shown in FIG. 1, particular embodiments may include any number of user devices. User device 102 includes any type of device capable of communicating with other devices and systems through data communication network 104. An example user devices 102 includes a cellular phone, a smart phone, a tablet computer, a laptop computer, a desktop computer, a portable entertainment device, a portable gaming device, a set top box, and the like. Data communication network 104 may utilize any communication protocol and any type of communication medium. In some embodiments, data communication network 104 is a combination of two or more networks coupled to one another.

An online merchant 106 and a parcel delivery service 108 are also coupled to data communication network 104. In some embodiments, online merchant 106 and a parcel delivery service 108 implement one or more computer systems, such as servers, to perform various operations and interact with other devices and systems via data communication network 104. A local merchant 110 is also coupled to data communication network 104. Local merchant 110 uses one or more computer systems, such as servers, to implement a delivery management system 112. Delivery management system 112 manages the receiving of product shipments from online merchant 108 and the delivery of those product shipments to appropriate users. A database 114, coupled to delivery management system 112, stores data used by delivery management system 112, such as user data, product data, delivery data, order data, and the like. Additional details regarding delivery management system 112 are provided herein.

Although one online merchant 106, one parcel delivery service 108, and one local merchant 110 are shown in FIG. 1, particular environments 100 may include any number of online merchants and parcel delivery services coupled to any number of local merchants.

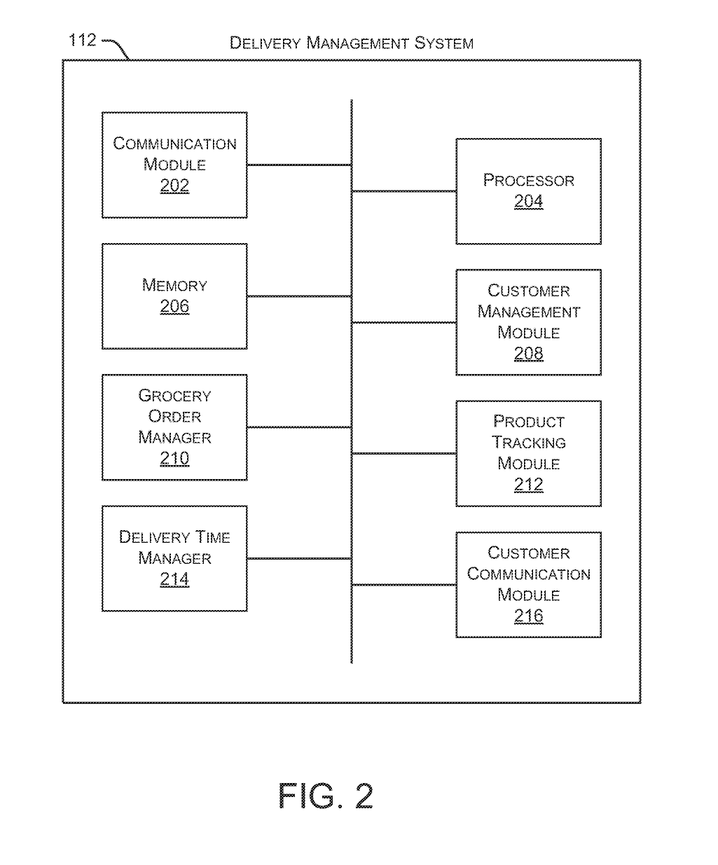

FIG. 2 is a block diagram depicting an embodiment of delivery management system 112. Delivery management system 112 includes a communication module 202, a processor 204, and a memory 206. Communication module 202 allows delivery management system 112 to communicate with other devices and systems, such as user device 102, online merchant 106, parcel delivery service 108, and the like. Processor 204 executes various instructions to implement the functionality provided by delivery management system 112. Memory 206 stores these instructions as well as other data used by processor 204 and other modules contained in delivery management system 112.

Delivery management system 112 also includes a customer management module 208 that manages customer information, customer orders, customer deliveries, and the like. A grocery order manager 210 manages various aspects of a grocery order, such as receiving grocery order contents, determining order volume, determining order weight, and scheduling delivery of a grocery order to a customer. Delivery management system 112 also includes a product tracking module 212, which tracks the location of received product shipments within the local merchant location. For example, when a product shipment is received for a customer from an online merchant, product tracking module 212 associates the product shipment with the customer identity, assigns a temporary storage location for the product shipment, and records that temporary storage location. By recording the temporary storage location, a delivery employee or system can easily locate the product shipment when preparing to deliver the product shipment to the customer.

Delivery management system 112 further includes a delivery time manager 214 that handles the scheduling of deliveries from the local merchant to the customer. These deliveries may include a grocery order as well as a product shipment for the customer that was received from an online merchant. As discussed herein, the scheduling of deliveries considers the volume of the order (both groceries and products from an online merchant), the weight of the order, the time required to deliver the order, available space on delivery vehicles, and the like. A customer communication module 216 interacts with one or more customers regarding grocery orders, products received from online merchants, delivery of orders and products, delivery reminders, and the like.

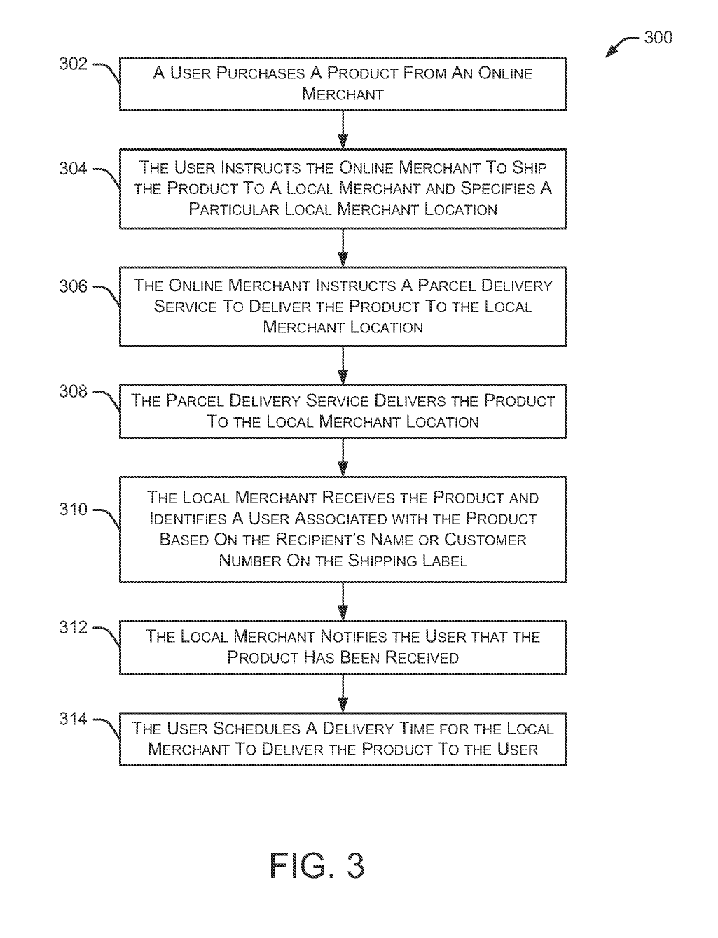

FIG. 3 is a flow diagram depicting an embodiment of a method 300 for delivering a product from an online merchant to a local merchant location. Initially, a user purchases a product from an online merchant at 302. The user instructs the online merchant to ship the product to a local merchant and specifies a particular local merchant location at 304. For example, as part of the check-out process with the online merchant, the user may select from multiple local merchants that can receive the product shipment. If the selected local merchant has multiple physical locations (e.g., multiple local stores), the user selects a particular local merchant location to receive the product shipment. In some embodiments, local merchants with multiple physical locations may only receive product shipments at a few of the locations. In this situation, the user selects from the physical locations that are available to receive the product shipment.

Method 300 continues as the online merchant instructs a parcel delivery service (or mail delivery service) to deliver the product to the local merchant location at 306. The parcel delivery service then delivers the product to the local merchant location at 308. The local merchant receives the product at 310 and identifies a user associated with the product based on the recipient's name or customer number on the shipping label. Additionally, information about the user can be identified from a customer management system, customer database or other system that manages customers of the local merchant. For example, a customer management system may identify the user's email address, phone number, delivery address, and the like. The local merchant then notifies the user at 312 that the product has been received at the local merchant location. Finally, the user schedules a delivery time for the local merchant to deliver the product to the user at 314. As discussed herein, delivery of the product may be combined with a delivery of groceries or other items from the local merchant.

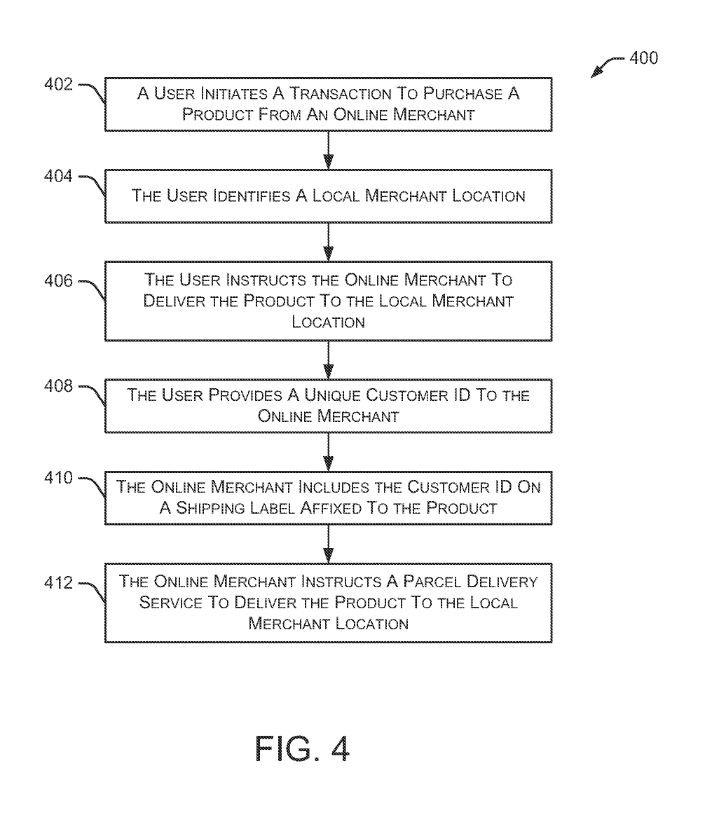

FIG. 4 is a flow diagram depicting an embodiment of a method 400 for allowing a user to select a local merchant location for delivery of a product purchased from an online merchant. Initially, a user initiates a transaction to purchase a product from an online merchant at 402. The user then identifies a local merchant location at 404. For example, the local merchant may be identified from a list of merchants located geographically close to the user's shipping address. The user instructs the online merchant to deliver the product to the local merchant location at 406. Method 400 continues as the user provides a unique customer ID to the online merchant at 408. This customer ID is known by the local merchant and allows the local merchant to quickly associate the product shipment with the user. In some embodiments, the customer ID is a series of numbers or alphanumeric characters. The online merchant prepares a shipping label at 410 that includes the customer ID along with other shipping information, such as the user's name, local merchant name, local merchant address, local merchant phone number, and the like. The shipping label is affixed to the package used to ship the product. The online merchant then instructs a parcel delivery service or mail delivery service to deliver the product to the local merchant location at 412.

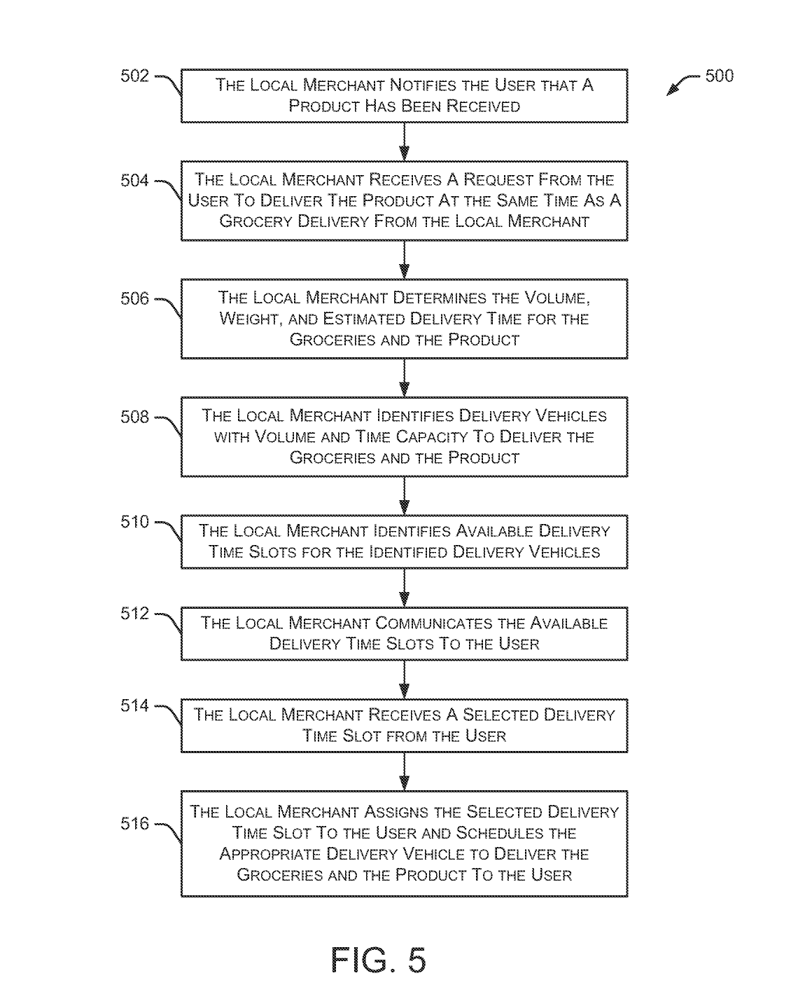

FIG. 5 is a flow diagram depicting an embodiment of a method 500 for determining delivery times for a product purchased from an online merchant. Initially, the local merchant notifies the user that a product has been received at 502. The local merchant receives a request from the user at 504 to deliver the product at the same time as a grocery delivery from the local merchant. In some embodiments, the user may delay delivery of the product, such as when the product is a gift and the user desires delivery close to a date when the gift is to be presented. In particular embodiments, the local merchant may receive a request to deliver the package by itself (i.e., without delivering any groceries) or with another non-grocery item.

The local merchant determines a volume, weight, and estimated delivery time for the groceries and the product at 506. For example, the total volume and weight associated with the groceries and the product are calculated based on the known volume and weight of the individual grocery items and the product. The estimated delivery time is determined based on the volume and weight of the items and the delivery location (e.g., stairs or a long walk). For example, if a large product is being delivered up several flights of stairs, the estimated delivery time is extended to accommodate the size of the product and delivery situation. In some embodiments, the volume and weight of the product are determined upon receipt of the product and stored by the delivery management system 112 (FIG. 1). The local merchant also identifies delivery vehicles at 508 with volume and time capacity to deliver the groceries and the product. The local merchant then identifies available delivery time slots (also referred to as “time windows”) for the identified delivery vehicles at 510.

Method 500 continues as the local merchant communicates the available delivery time slots to the user at 512. The user then selects a delivery time slot that is convenient for the user. The local merchant receives the selected delivery time slot from the user at 514. Finally, the local merchant assigns the selected delivery time slot to the user at 516 and schedules the appropriate delivery vehicle to deliver the groceries and the product to the user.

In some embodiments, the local merchant receives an online grocery order from a customer. Upon receipt of the grocery order, the delivery management system 112 determines whether any parcels are awaiting delivery to the customer. If a parcel is identified, the local merchant offers to deliver the parcel to the customer along with the grocery order. If the user accepts the offer, the delivery management system 112 schedules a delivery of both the grocery order and the parcel. If the user declines the offer, the package remains at the local merchant for a future delivery to the customer.

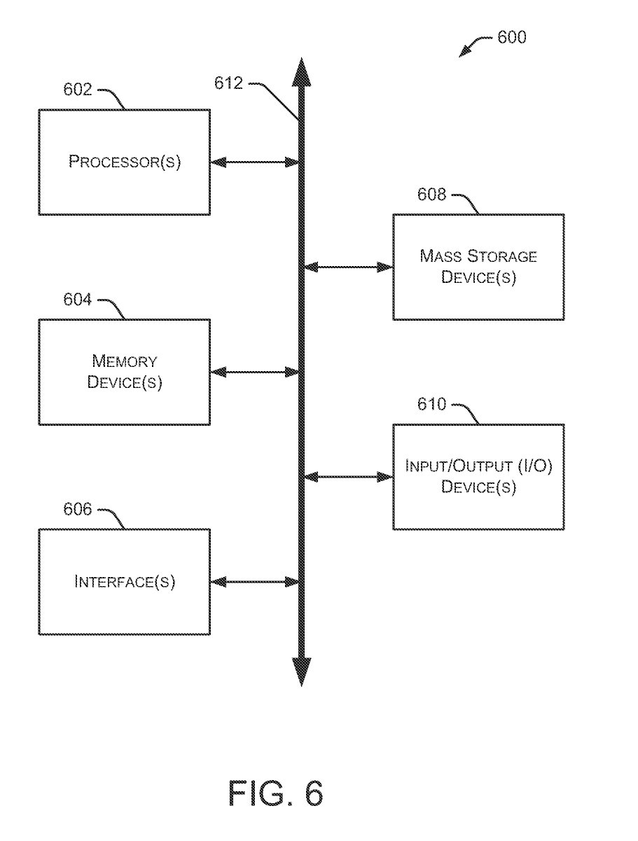

FIG. 6 is a block diagram depicting an example computing device 600. Computing device 600 may be used to perform various procedures, such as those discussed herein. Computing device 600 can function as a server, a client or any other computing entity. Computing device 600 can be any of a wide variety of computing devices, such as a desktop computer, a notebook computer, a server computer, a handheld computer, a tablet, and the like.

Computing device 600 includes one or more processor(s) 602, one or more memory device(s) 604, one or more interface(s) 606, one or more mass storage device(s) 608, and one or more Input/Output (I/O) device(s) 610, all of which are coupled to a bus 612. Processor(s) 602 include one or more processors or controllers that execute instructions stored in memory device(s) 604 and/or mass storage device(s) 608. Processor(s) 602 may also include various types of computer-readable media, such as cache memory.

Memory device(s) 604 include various computer-readable media, such as volatile memory (e.g., random access memory (RAM)) and/or nonvolatile memory (e.g., read-only memory (ROM)). Memory device(s) 604 may also include rewritable ROM, such as Flash memory.

Mass storage device(s) 608 include various computer readable media, such as magnetic tapes, magnetic disks, optical disks, solid state memory (e.g., Flash memory), and so forth. Various drives may also be included in mass storage device(s) 608 to enable reading from and/or writing to the various computer readable media. Mass storage device(s) 608 include removable media and/or non-removable media.

I/O device(s) 610 include various devices that allow data and/or other information to be input to or retrieved from computing device 600. Example I/O device(s) 610 include cursor control devices, keyboards, keypads, microphones, monitors or other display devices, speakers, printers, network interface cards, modems, lenses, CCDs or other image capture devices, and the like.

Interface(s) 606 include various interfaces that allow computing device 600 to interact with other systems, devices, or computing environments. Example interface(s) 606 include any number of different network interfaces, such as interfaces to local area networks (LANs), wide area networks (WANs), wireless networks, and the Internet.

Bus 612 allows processor(s) 602, memory device(s) 604, interface(s) 606, mass storage device(s) 608, and I/O device(s) 610 to communicate with one another, as well as other devices or components coupled to bus 612. Bus 612 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 600, and are executed by processor(s) 602. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

Although the present disclosure is described in terms of certain preferred embodiments, other embodiments will be apparent to those of ordinary skill in the art, given the benefit of this disclosure, including embodiments that do not provide all of the benefits and features set forth herein, which are also within the scope of this disclosure. It is to be understood that other embodiments may be utilized, without departing from the scope of the present disclosure.

1. A method comprising:
receiving a parcel shipped from an online merchant, wherein the parcel is received by a local merchant;
identifying a customer identity affixed to the parcel;
identifying, using one or more processors, a particular customer based on the customer identity;
identifying, using the one or more processors, contact information associated with the particular customer;
notifying, using at least a portion of the contact information, the particular customer of the parcel;
receiving, from the particular customer, a request to deliver the parcel and a grocery order to the particular customer; and
scheduling delivery of the parcel and the grocery order to the particular customer.

2. The method of claim 1, wherein identifying a customer identity associated with the parcel includes identifying a customer name on a shipping label affixed to the parcel.

3. The method of claim 1, wherein identifying a customer identity associated with the parcel includes identifying a unique customer ID affixed to the parcel.

4. The method of claim 1, further comprising:
calculating a weight and volume associated with the parcel; and
communicating the weight and volume associated with the parcel to a delivery management system.

5. The method of claim 1, further comprising:
storing the parcel at a physical location within the local merchant; and
communicating the physical location of the parcel to a delivery management system.

6. The method of claim 1, wherein scheduling delivery of the parcel and the grocery order includes determining a total volume associated with the parcel and the grocery order.

7. The method of claim 1, wherein scheduling delivery of the parcel and the grocery order includes determining a total weight associated with the parcel and the grocery order.

8. The method of claim 1, wherein scheduling delivery of the parcel and the grocery order includes:
determining a total volume associated with the parcel and the grocery order;
determining a total weight associated with the parcel and the grocery order;
identifying delivery vehicles with volume and weight capacity to deliver the parcel and the grocery order; and
communicating available delivery times to the particular customer based on the identified delivery vehicles.

9. The method of claim 1, wherein scheduling delivery of the parcel and the grocery order includes:
determining a total volume associated with the parcel and the grocery order;
determining a total weight associated with the parcel and the grocery order;
identifying delivery vehicles with volume and weight capacity to deliver the parcel and the grocery order;
identifying a plurality of available delivery time slots based on the identified delivery vehicles; and
communicating the plurality of available delivery time slots to the particular customer.

10. The method of claim 9, further comprising:
receiving a selected delivery time slot from the particular customer;
identifying a particular delivery vehicle associated with the selected delivery time slot; and
scheduling the particular delivery vehicle to deliver the parcel and the grocery order.

11. The method of claim 1, wherein scheduling delivery of the parcel and the grocery order includes:
determining a total volume associated with the parcel and the grocery order;
determining a total weight associated with the parcel and the grocery order;
estimating a delivery time to deliver the parcel and the grocery order;
identifying delivery vehicles with volume capacity, weight capacity, and available time to deliver the parcel and the grocery order;
identifying a plurality of available delivery time slots based on the identified delivery vehicles; and
communicating the plurality of available delivery time slots to the particular customer.

12. The method of claim 11, wherein estimating a delivery time to deliver the parcel and the grocery order includes determining delivery conditions at a delivery address associated with the particular customer.

13. The method of claim 11, wherein estimating a delivery time to deliver the parcel and the grocery order is based on the total volume and the total weight of the parcel and the grocery order.

14. A method comprising:
receiving, using one or more processors, an online grocery order from a customer, the customer having a customer identity, wherein the online grocery order is received by a local merchant;
identifying, using the one or more processors, at least one parcel awaiting delivery to the customer based on the customer identity, wherein the parcel was received by the local merchant from a different online merchant;
notifying the customer of the at least one parcel awaiting delivery; and
offering to deliver the at least one parcel to the customer with the grocery order.

15. The method of claim 14, further comprising:
receiving, from the customer, a response to the offer to deliver the at least one parcel with the grocery order; and
delivering the at least one parcel with the grocery order responsive to receiving a positive response to the offer.

16. The method of claim 14, further comprising scheduling delivery of the parcel and the grocery order to the particular customer responsive to receiving a positive response to the offer to deliver the at least one parcel with the grocery order.

17. The method of claim 16, wherein scheduling delivery of the parcel and the grocery order includes:
determining a total volume associated with the parcel and the grocery order;
determining a total weight associated with the parcel and the grocery order;
identifying delivery vehicles with volume and weight capacity to deliver the parcel and the grocery order;
identifying a plurality of available delivery time slots based on the identified delivery vehicles; and
communicating the plurality of available delivery time slots to the customer.

18. The method of claim 17, further comprising:
receiving a selected delivery time slot from the customer;
identifying a particular delivery vehicle associated with the selected delivery time slot; and
scheduling the particular delivery vehicle to deliver the parcel and the grocery order.

19. An apparatus comprising:
a memory to store data associated with an online order; and
one or more processors coupled to the memory, the one or more processors configured to:
receive a parcel shipped from an online merchant, wherein the parcel is received by a local merchant;
identify a customer identity affixed to the parcel;
identify a particular customer based on the customer identity;
identify contact information associated with the particular customer;
notify, using at least a portion of the contact information, the particular customer of the parcel;
receive, from the particular customer, a request to deliver the parcel and a grocery order to the particular customer; and
schedule delivery of the parcel and the grocery order to the particular customer.

20. The apparatus of claim 19, the one or more processors further configured to:
determine a total volume associated with the parcel and the grocery order;
determine a total weight associated with the parcel and the grocery order;
identify delivery vehicles with volume and weight capacity to deliver the parcel and the grocery order; and
communicate available delivery times to the particular customer based on the identified delivery vehicles.
